(19) United States
(12) Patent Application Publication
(10) Pub. No.: US 2012/0160585 A1
(43) Pub. Date: Jun. 28, 2012

(54) CARRIER AND HOLDER FOR A VEHICLE BATTERY

(75) Inventor: Udo MILDNER, Limburg (DE)

(73) Assignee: GM GLOBAL TECHNOLOGY OPERATIONS LLC, Detroit, MI (US)

(21) Appl. No.: 13/337,523

(22) Filed: Dec. 27, 2011

(30) Foreign Application Priority Data
Dec. 28, 2010 (DE) 102010056391.9

(51) Int. Cl. B60R 16/04

(52) U.S. Cl. 180/68.5

(57) ABSTRACT

A carrier is provided for a vehicle battery and a holder for securing the vehicle battery in position in the direction of at least one spatial axis. The carrier comprises a base having a support surface for the vehicle battery and having at least two projections protruding from the base, between which the vehicle battery can be disposed. The holder can be attached to the projections. It is provided that at least one of the projections is formed on the carrier.

### CROSS-REFERENCE TO RELATED APPLICATION

This application claims priority to German Patent Application No. 102010056391.9, filed Dec. 28, 2010, which is incorporated herein by reference in its entirety.

### TECHNICAL FIELD

The technical field relates to a carrier for a vehicle battery as well as a holder for a vehicle battery as well as a holder for securing a vehicle battery in position in the direction of at least one spatial axis.

### BACKGROUND

In the course of the development of new generations of motor vehicles, attempts are being made to reduce the dimensions of the vehicles and therefore their overall weight in order to meet the legal requirements for the reduction of CO2 emission in future. One possible measure in this direction is that the overhang of the motor vehicle over its front wheels is shortened so that the bumper cross member of the vehicle is displaced toward the front wheels. However, this is associated with a reduction in the size of the engine compartment of the motor vehicle so that for some of the components presently located in the engine compartment a different location must be found to accommodate them. One of the components considered in these considerations is the starter battery, which has a relatively large space requirement so that its accommodation outside the engine compartment would allow a considerable reduction in the size of the engine compartment.

In future generations of vehicles, an attempt will therefore be made to accommodate the starter battery, for example, in the trunk of the motor vehicle or below the seats of the motor vehicle, in particular the front seats. However, recesses or depressions in which the starter battery is to be inserted are frequently formed in these areas of the motor vehicle. For this reason already the mounting of the starter battery, for example, in the course of the final assembly of the motor vehicle and also exchange of the starter battery is difficult.

Installation of the starter battery or its exchange is more difficult by the necessary fixing of the battery on the vehicle body. An appropriate retaining device or clamping device is usually provided for this purpose, which can only be mounted with relative high effort when a starter battery is located in a depression or a recess since individual components of the clamping device are covered by components of the motor vehicle such as, for example, the front seats.

It is therefore at least one object to develop a fastening concept for a vehicle battery by which a vehicle battery located in a recess of the vehicle body is adequately fixed and at the same time, installation and disassembly of the vehicle battery can be carried out simply. In addition, other objects, desirable features, and characteristics will become apparent from the subsequent summary and detailed description, and the appended claims, taken in conjunction with the accompanying drawings and this background.

### SUMMARY

A carrier is provided for a vehicle battery and by a holder for securing the vehicle battery in position in the direction of at least one spatial axis. Furthermore, a preassembled unit is proposed for fixing a vehicle battery in a motor vehicle.

A carrier for a vehicle battery comprises a base having a support surface for the vehicle battery and having at least two projections protruding from the base, between which the vehicle battery can be disposed. At least one holder can be attached to the projections, which serves to secure the vehicle battery in position in the direction of at least one spatial axis. At least one of the projections is formed on the carrier.

By means of the carrier, it is possible to adequately fix a vehicle battery in a recess or depression of the motor vehicle in a simple manner. At the same time, despite its difficult installation position in the motor vehicle, due to the carrier the vehicle battery can be installed and dismounted again with relatively little effort. As a result of the projections it is specifically avoided that the fixing of the vehicle battery on the carrier is accomplished in its base region but can take place in an elevated region from the base region. Such an elevated region is easier to reach from outside compared with the base region, in particular when carrier and vehicle battery are installed in a depression or recess of the vehicle body.

Since the projections, in particular domes, are formed on the carrier, securing of the vehicle battery in position is achieved by a particularly simple handling since the holder merely needs to be attached to the projections for this purpose. The projections as parts of the fastening concept for the vehicle battery need not be held as separate parts but are an integrated component of the carrier and are already installed together with the carrier in the installation location on the motor vehicle. In this respect, logistic advantages are also obtained in the course of the final assembly of the motor vehicle in the works, since the supply of projections as separate parts is avoided.

According to a first embodiment, it is provided that at least one of the projections is formed on the base and/or on a side wall of the carrier. By this means a stable combination of the projections with the carrier is achieved so that together with the holder, a sustainable securing in position can be achieved for the vehicle battery which even withstands greater vibrations, for example, when traveling on rough terrain.

According to another embodiment, it is provided that at least one of the projections is disposed at a distance from an adjacent side wall of the carrier. As a result, free installation space is achieved between the one projection and the neighboring side wall that can be used for receiving other components of the motor vehicle or supplementary components such as, for example, a fuse box or for receiving cable. It is appropriate that the carrier has a plurality of side walls which are preferably disposed circumferentially. It is furthermore appropriate that the carrier is configured in a trough-shape. As a result, the environment around the carrier is protected from escaping battery fluid that remains inside the carrier as a result of the trough shape.

It is appropriate that the projections extend substantially as far as into the area of the upper side of the vehicle battery. As a result, the holder for securing the vehicle battery in position can be reached particularly well from outside even when the vehicle battery together with the carrier is to be accommodated or is already accommodated in a depression or recess of the motor vehicle. The measure that the projections are configured so that the holder can be fixed on the upper side thereof is also aimed in the same direction.

According to a further embodiment, at least one clamping wedge is provided, which wedge is disposed on the base and extends onto the contact surface or into the area of the contact surface. As a result, in the interplay of clamping wedge and holder, a securing of the vehicle battery in position in the direction of at least one spatial axis is achieved in which the vehicle battery is held clamped between holder and contact surface of the carrier or base of the carrier. For this purpose, the vehicle battery is preferably pushed so far onto a section of the clamping wedge that as a result of the mounting of the holder, the holder and at least one section of the contact surface together with at least one section of the clamping wedge enter into clamping position with respect to the vehicle battery. To this end, the clamping wedge is preferably disposed on the base or the contact surface of the carrier system in such a manner that the flat end of the sloping wedge surface of the clamping wedge points in the direction of the vehicle battery and the high end points in the direction of the side wall of the carrier.

The clamping wedge is preferably formed on the carrier. Naturally, the at least one clamping wedge can also be a separate component which is placed loosely on the base or the contact surface of the carrier or is screwed, riveted, and/or locked onto the base or the contact surface of the carrier. The at least one clamping wedge can be disposed on the base of the carrier in such a manner that in the installed state of the vehicle battery, the clamping wedge comes into operative position against the vehicle battery on the longitudinal side of the battery base. In principle, it is also possible that the clamping wedge is disposed on the base or the contact surface of the carrier in such a manner that the clamping wedge comes into operative position against the vehicle battery on one of the longitudinal sides of the battery base.

According to an embodiment, it can be provided that the at least one clamping part is disposed on the contact surface or the base of the carrier in such a manner that the clamping wedge comes into operative position on a rear transverse side of the vehicle battery and the holder which can be mounted on the projections comes into operative position against the vehicle battery on its front transverse side. The holder can come into operative contact or press against the upper side of the vehicle battery and the at least one clamping wedge can come into operative contact or press against the underside of the vehicle battery.

According to a preferred embodiment, it is provided that at least one of the projections has a fixing point for attachment of the holder, through which the holder can be twisted about at least one spatial axis in the mounted state. As a result, the holder can be pivoted from an initial position into an operative position in which the holder then comes into operative contact with the other projection and serves as securing in position for the vehicle battery.

In the initial position, the holder can for example be present in a position in which the vehicle battery can be inserted in the free space between the two projections. In the initial position the holder can thus be pivoted out of the operative region for securing the vehicle battery. In the initial position, the holder can be lowered, for example, in a receptacle of the side wall of the carrier so that the holder lies in a protected position.

It is appropriate that the fixing point comprises a curved contact surface, which can be brought into operative position with a corresponding counter-contact surface of the holder. Due to the curved contact surface, mobility of the holder is possible relative to the projection mounted thereon in more than one spatial axis. In order to be able to move the holder with respect to the at least one projection about arbitrary spatial axes, it is appropriate that the contact surface is formed by a spherical section and the counter-contact surface has a corresponding spherical section. Preferably, the contact surface should be inwardly curved and the counter-contact surface should be outwardly curved. The inwardly curved contact surface can be produced in a simple manner on the projection.

An embodiment provides that the fixing point has an opening or similar receptacle for receiving a connecting element connecting the holder to the carrier. In this way, a connection between holder and projection can be achieved in a technically simple manner. The connecting element can be configured so that a nondetachable connection is formed between holder and carrier. The connecting element can, for example, be a rivet so that holder and carrier are interconnected by means of a rivet connection and can be mounted so that they can be twisted toward one another.

According to another embodiment, it is provided that another of the projections has a fixing point for detachable connection to the holder. The holder can thereby be released at the other projection if necessary, for example, for dismounting the vehicle battery and brought into a position which enables the removal of the vehicle battery from the carrier. It is appropriate that the fixing position has a tapped hole. A detachable connection between the projection and the holder can thereby be achieved in a particularly simple manner whereby, for example, a fastening screw is screwed into the tapped hole of the fixing position with the holder interposed.

According to another embodiment, it is provided that the carrier has a lock for fixing the holder in a position through which an insertion region for insertion of the vehicle battery from above in the direction of the base carrier is exposed between the projections. The holder is thereby brought into a position in which the vehicle battery can be installed without the holder needing to be moved for this purpose. Only after placing the vehicle battery on the contact surface and positioning the vehicle battery with respect to the carrier will the holder is brought from this initial position into a fastening position in which the holder then acts as securing in position in relation to the vehicle battery. Due to the locking the holder is held firmly in the initial position so that when installing the carrier, the holder already pre-positioned thereon remains held in the initial position. It is appropriate that the locking is located on one of the side walls of the carrier, in particular is formed thereon. The locking is thereby particularly simple to achieve. It is furthermore appropriate that the locking is formed by a clip-like material section in which the holder can be suspended. As a result, the locking is achieved in a particularly simple manner.

In order to produce the carrier cost-effectively, it is appropriate that the carrier consists of plastic such as, for example, polyamide and/or polypropylene. It is furthermore appropriate that the carrier is an injection molded part. For reinforcement the carrier can be glass fiber reinforced, in particular it can consist of glass fiber reinforced plastic.

A holder for securing a vehicle battery in position in the direction of at least one spatial axis is characterized inter alia in that the holder is configured for mounting on a carrier of the type described hereinbefore. The holder can be formed at least partially of plastic, for example, it can be formed of polyamide and/or propylene. The holder can also be at least partially formed of glass fiber reinforced plastic material. The holder can be an injection molded part. It is feasible that holder and carrier consist of the same material.

It is appropriate that the holder has a receptacle for storing a connecting element, which is used to connect the holder to the carrier. The connecting element is thereby already held nondetachably on the holder before mounting the holder on the carrier. A separate provision of the connecting element and also a separate handling of parts in the course of the final assembly of the motor vehicle in relation to the connecting element is thereby avoided since the connecting element is already prepositioned on the holder. During assembly for fastening the vehicle battery the connecting element merely needs to be taken out from the receptacle on the holder and can then be used for connecting holder and carrier.

It is appropriate that a fixing element is provided, through which the connecting element is held on the holder in a fixed position, in particular a locked position. The fixing element can be detachably disposed on the holder so that by removing the fixing element from the holder the connecting element can be removed in a simple manner from the holder.

The holder can be configured in a clip shape. The holder can furthermore have a ribbed structure which preferably extends in the longitudinal direction of the holder. As a result, the holder is stiffened or reinforced in the direction of its longitudinal axis so that the holder remains substantially dimensionally stable even when a relatively high clamping force is applied to the vehicle battery.

According to an embodiment it is provided that the holder has a counter-contact surface, at which the holder can be brought into operative position with a contact surface of the carrier to form a pivot bearing. By this means the holder is rotatably mounted in the installed state on the carrier so that the holder can be pivoted from the initial position into the fixing position or clamping position in relation to the vehicle battery. For attachment of the holder to the carrier, the holder has at least two fixing points which can be brought into operative contact with the fixing points on the projections of the carrier. It is appropriate that the fixing points of the holder and the fixing points of the projections have through holes. It is thereby possible to connect holder and carrier at the respective fixing points by a connecting element, for example, in the form of a screw or rivet.

According to an embodiment, a preassembled unit is provided for fixing a vehicle battery in a motor vehicle. The preassembled unit has a carrier of the type described hereinbefore and a holder of the type described hereinbefore, where the carrier and holder are interconnected by at least one connecting element, in particular are undetachably interconnected. The connecting element can be configured as a rivet, so that holder and carrier can be undetachably interconnected by a rivet connection.

It is appropriate that the holder is mounted rotatably on the carrier with the connection. As a result, before mounting the unit in the motor vehicle, the holder can be brought into a position in which a vehicle battery can be inserted between the projections of the carrier and can be placed on the contact surface of the carrier without the holder have an interfering effect. Only by pivoting the holder into a fastening position, can the holder then be fixed on the carrier, in particular the other projection and the fixing of the vehicle battery on the carrier can thereby be achieved.

A vehicle battery can be achieved in a simple manner and through ergonomically favorable reachability of the components for fixing the vehicle battery. By pre-positioning individual components of the fastening concept for the vehicle battery and the possibility of achieving a pre-assembled unit of carrier and holder, the assembly effort overall and the assembly time for the vehicle battery is reduced. Additional transport of parts is also avoided so that cost savings are achieved.

The embodiments are suitable for the fastening of a starter battery as vehicle battery. It is also feasible that a traction battery for an electric-motor driven motor vehicle is used as vehicle battery.

### BRIEF DESCRIPTION OF THE DRAWINGS

The present invention will hereinafter be described in conjunction with the following drawing figures, wherein like numerals denote like elements, and:

FIG. 1 shows a vehicle battery installed in an embodiment of a fastening device for a vehicle battery that can be integrated in a motor vehicle in perspective view;

FIG. 2 shows a perspective view of the carrier of the fastening device holding the vehicle battery according to FIG. 1;

FIG. 3 shows a perspective view of the holder of the fastening device according to FIG. 1;

FIG. 4 shows the fastening device according to FIG. 1 in sectional view along the line of intersection A-A according to FIG. 1;

FIG. 5 shows the region of the fastening device marked by “X” in FIG. 5; and

FIG. 6 shows a perspective view of the carrier and the holder of the fastening device according to FIG. 1 as a pre-assembled unit.

### DETAILED DESCRIPTION

The following detailed description is merely exemplary in nature and is not intended to limit application and uses. Furthermore, there is no intention to be bound by any theory presented in the preceding background or summary or the following detailed description.

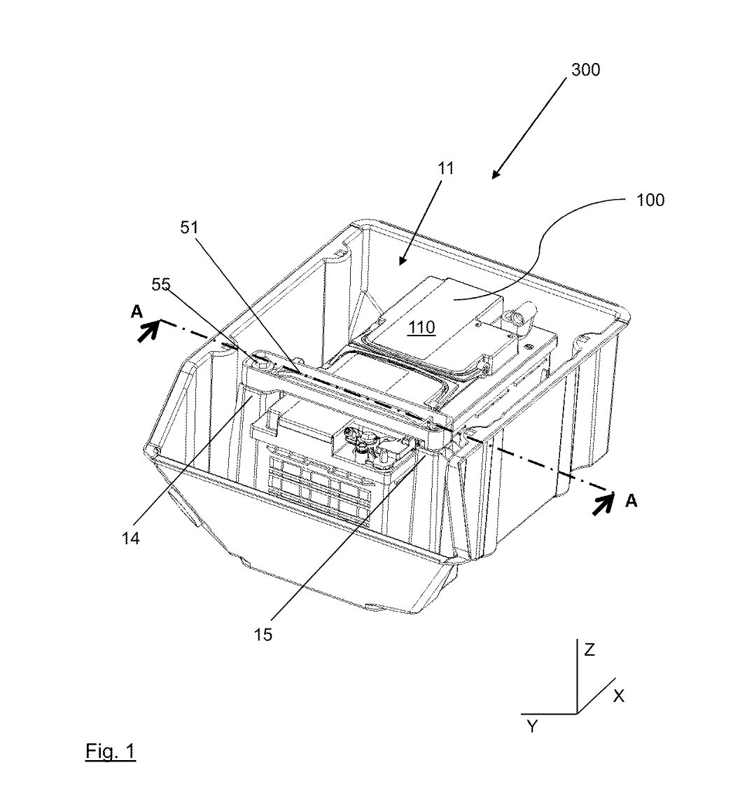

FIG. 1 shows, in schematic view, a fastening device 300 by means of which a vehicle battery 100 is installed on or in a (not shown in FIG. 1) vehicle body of a motor vehicle. The fastening device 300 together with the vehicle battery 100 can be installed in a recess or depression of the motor vehicle, in particular the vehicle body. The vehicle battery 100 is preferably a starter battery. In principle, the vehicle battery 100 can also be a traction battery that delivers the electric current for driving an electric drive of the motor vehicle.

The fastening device 300 has a carrier 11 that carries the vehicle battery 100. Two projections 14, 15, in particular domes, are assigned to the carrier 11, between which the vehicle battery 100 is disposed. The projections 14, 15 extend substantially into the area of the upper side 110 of the vehicle battery 100. A holder 51 is fastened to the projections 14, 15, which grips the upper side 110 of the vehicle battery 100 and is preferably connected to the projections 14, 15 at its lateral end regions. The vehicle battery 100 is disposed between the projections 14, 15 and the holder 51 so that the vehicle battery 100 is thereby held secured in position on the carrier 11. The vehicle battery 100 is preferably clamped by the holder 51 against the carrier 11 so that the vehicle battery 100 is held secured in position on the carrier 11 in the direction of the spatial axes X, Y and Z.

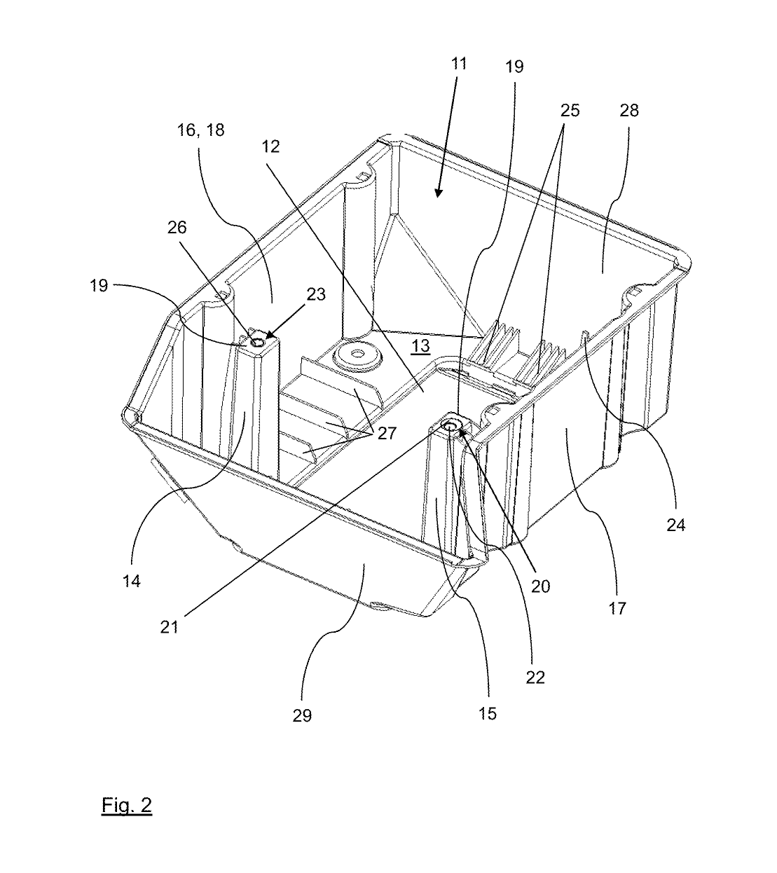

FIG. 2 shows the carrier 11 of the fastening device 300 according to FIG. 1 alone. As can be seen from this, the carrier 11 has a contact surface 12 for the vehicle battery 100 (not shown in FIG. 2) which is integrated in the base 13 of the carrier 11. A plurality of reinforcing ribs 27 are disposed around the contact surface 12, at least on the base 13, in particular on the base 13. The carrier 11 furthermore has side walls 16, 17, 28, 29 which are arranged circumferentially so that the carrier 11 is configured in the manner of a trough.

Of the projections 14, 15 at least the projection 15 is connected to the side wall 17, in particular is formed on the side wall 17. The other projection 14 is preferably disposed to an adjacent side wall 18 so that a free space is obtained between the projection 14 and the side wall 18. The projections 14 and 15 are further disposed on the base 13, preferably outside the contact surface 12, in particular formed on the base 13.

Furthermore, at least two clamping wedges 25 are provided in the base 13, which extend at least partially as far as the contact surface 12 so that when receiving the vehicle battery 100 (not shown in FIG. 2), the vehicle battery 100 can be pushed onto the sloping run-on surface of the clamping wedge 25 at least over a section and when the holder 21 is mounted a clamping of the vehicle battery 100 on the carrier 11 is thereby produced.

On their respective upper side 19, which forms the end of the spatial extension of the projections 14, 15 in the direction of the spatial axis Z, the projections 14, 15 each have a fixing point 20 or 23 at which the holder 51 can be fixed. The fixing point 23 of the projection 14 has an opening 26 in which a connecting element (not shown in FIG. 2) can be received. The opening 26 is preferably configured as a tapped hole in order to mount the holder 51 by means of screws on the projection 14 so that the holder 51 is detachably fastened by means of a screw connection on the projection 14.

The fixing point 20 of the projection 15 has a curved contact surface 21 which is preferably inwardly curved. The contact surface 21 forms the boundary for an opening 22 let into the projection 15, which is preferably configured as a through opening. The opening 22 is configured for receiving a connecting means (not shown in FIG. 2) for connecting the holder 51 (not shown in FIG. 2) to the projection 15.

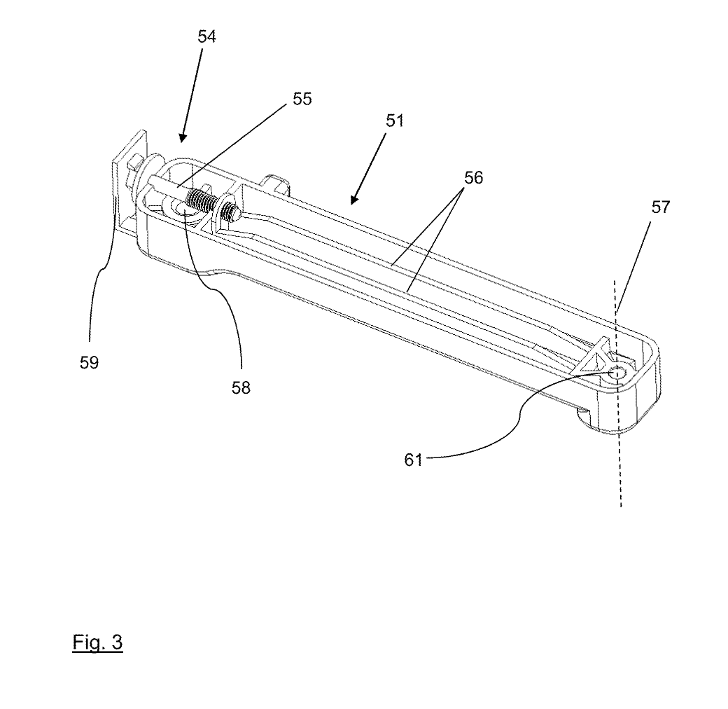

FIG. 3 shows the holder 51 of the fastening device 300 alone. The holder 51 is preferably configured in the manner of a clip which has respectively one through opening 58 and 61 in the direction of its longitudinal extension on its two opposite end regions, where the holder 51 preferably has a ribbed structure 56 for reinforcement in the region between the through openings 58 and 61. The rib structure 56 thereby extends substantially in the direction of the longitudinal extension of the holder 51.

The holder 51 further has a receptacle 54 for storing a connecting element 55, which is used for connecting the holder 51 to the carrier 11. The connecting element 55 is preferably configured as a screw. In order to be able to store the connecting element 55 securely and protected from the outside in the receptacle 54, a protection part 59 detachable from the holder or fixing element is provided, which is preferably supported against the head of the connecting element 55, in particular brings about a locking of the head of the connecting element 55 against the protection part 59.

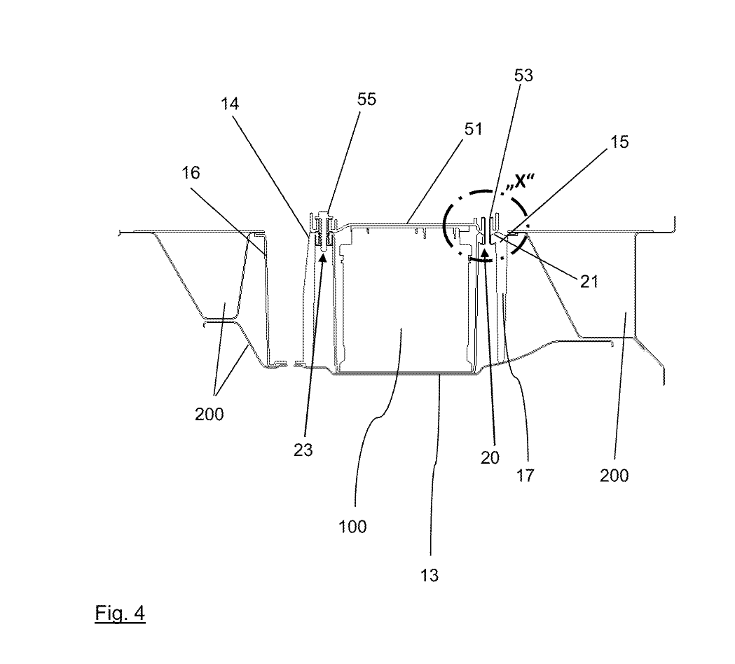

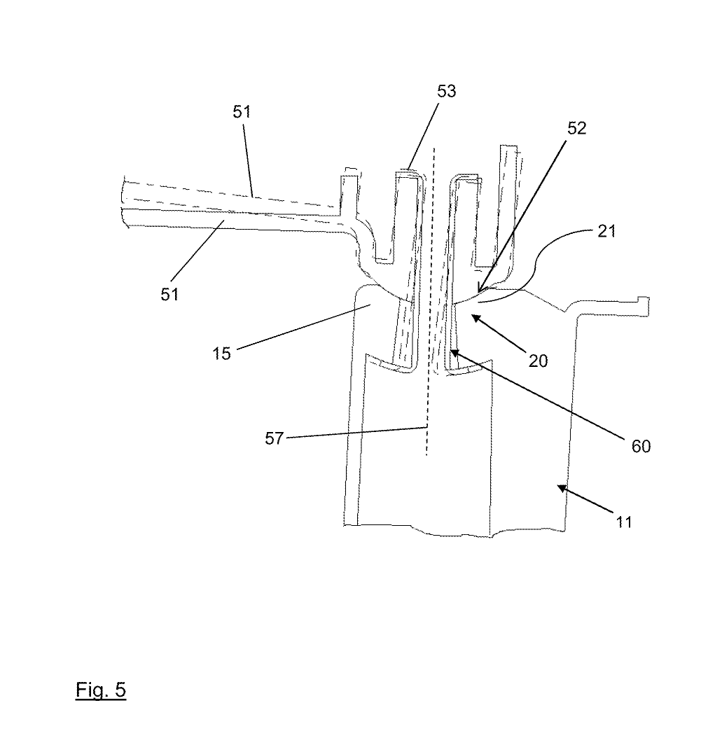

FIG. 4 shows the fastening device 300 in a sectional view along the section A-A according to FIG. 1, where the fastening device 300 in FIG. 4 is installed in a body structure 200 of a motor vehicle (not shown). Preferably for this purpose at least the side walls 16 and 17 are fastened on the body structure 200. As can be seen from FIG. 4, the holder 51 is fastened at the fixing point 20 of the projection 15 by means of a connecting element 53 on the projection 15, where the contact surface 21 of the projection 15 is brought into abutting contact with a counter-contact surface 52 of the holder 51 so that the contact surface 21 and the counter-contact surface 52 can slide toward one another, as can be seen from FIG. 5 in particular.

FIG. 5 shows the area of the connection of holder 51 and carrier 11 on the projection 15 in detail. As can be seen from this, the connecting element 53 is inserted through the through opening 61 of the holder 51 and the opening or through opening 22 of the projection 15 so that the holder 51 is mounted twistably about the axis of rotation 57 with respect to the projection 15 or the carrier 11. Due to the curved contact surface 21 on the projection 15 and the correspondingly curved counter-contact surface 52 of the holder 51, a twisting of the holder 51 relative to the projection 15 of the carrier 11 transversely to the axis of rotation 57 is additionally possible. A turning movement in the direction of the spatial axis Z can be seen for example in FIG. 5 by means of the drawn-in dashed lines.

The connecting element 53 is preferably configured as a rivet so that the connection of the holder 51 on the projection 15 of the carrier 11 is preferably formed by an undetachable rivet connection 60. The carrier 11 and the holder 51 thereby form a pre-assembled unit on which the holder 51 is permanently connected to the carrier 11. The connecting element 55 provided on the holder 51 in the receptacle 54 is used to make the connection of the holder 51 to the projection 14 of the carrier 11 so that a frame structure surrounding the vehicle battery 100 is thereby formed by means of the projections 14 and 15, the holder 51 and the base 13 of the carrier 11, as can be seen in particular from FIG. 4.

The connecting element 55 preferably configured as a screw is screwed into the tapped opening 26 of the projection 14 through the through opening 58 in the holder 51 in the mounted position of the holder 51. By screwing in the connecting element 55, the holder 51 is pressed against the upper side 110 of the vehicle battery 100 so that a clamping of the vehicle battery 100 takes place between base 13 and holder 51. The further the holder 51 is screwed in the direction of the projection 14 through the connecting element 55, the clamping effect can be increased until the holder 51 reaches the upper side 19 of the projection 14.

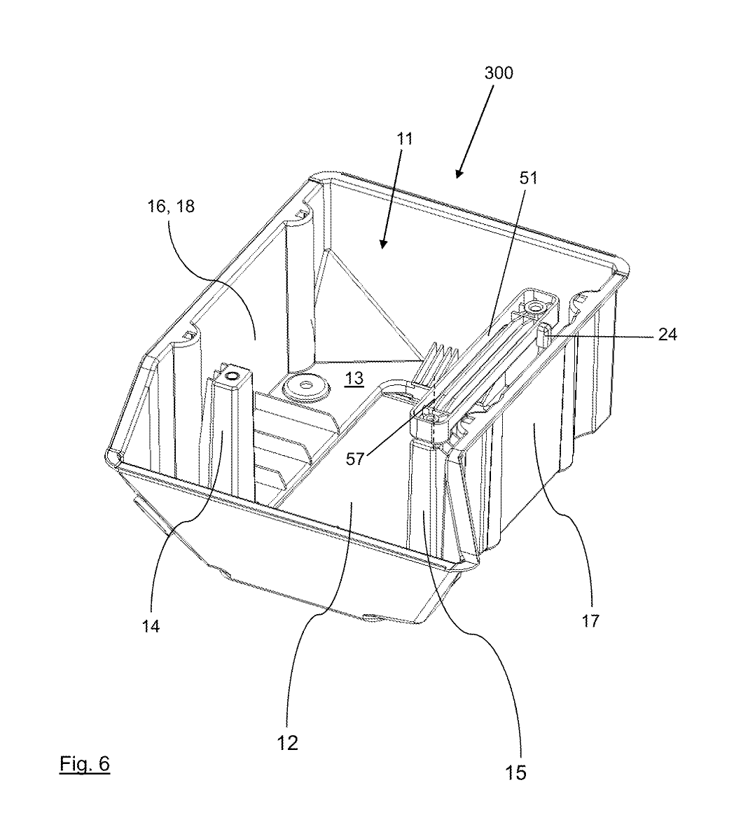

FIG. 6 shows the carrier 11 with the holder 51 mounted rotatably thereon in an initial position. In the initial position the holder 51 is pivoted about the axis of rotation 57 in the direction of the side wall 17 and locked in a lock 24 disposed on the side wall 17. The lock 24 is preferably formed by a clip which is preferably formed on the side wall 17 as can be seen from FIG. 2. In the initial position the insertion region between the projections 14 and 15 has been left free for insertion of the vehicle battery 100 so that in the initial position of the holder 51 the vehicle battery 100 can be placed in a simple manner onto the contact surface 12 of the carrier 11. After placing the vehicle battery 100 on the contact surface 12 of the carrier 11, the holder 51 can be brought by turning about the axis of rotation 57, from the initial position into a clamping position in which the holder 51 is then fixed on the projection 14 by means of the connecting element 55 and a fixing of the vehicle battery 100 in position on the carrier 11 is thereby achieved.

The carrier 11 and the holder 51 preferably are formed at least partially of plastic. Reinforcing elements for the openings 22 and 26 can be provided at the fixing points 20 and 23 of the projections 14 and 15, which are preferably configured, for example, as sleeves. The through openings 58 and 61 of the holder 51 can also be reinforced by reinforcing elements such as, for example, sleeves. Naturally it is also possible that only at least one opening 22 or 26 or 58 or 61 is reinforced by a reinforcing element, for example, in the manner of a sleeve. Such a reinforcing element prevents any release of the connection during settling effects of the plastic material.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A carrier for a vehicle battery, comprising:
a base having a support surface for the vehicle battery;
at least two projections protruding from the base between which the vehicle battery is configured for disposal and formed on the carrier; and
at least one holder attached to the at least two projections that serves to secure the vehicle battery in a position in a direction of at least one spatial axis.

2. The carrier according to claim 1, wherein at least one of the at least two projections is formed on the base of the carrier.

3. The carrier according to claim 1, wherein at least one of the at least two projections is formed on a side wall of the carrier.

4. The carrier according to claim 1, wherein at least one of the at least two projections is disposed at a distance from an adjacent side wall of the carrier.

5. The carrier according to claim 1, wherein the at least two projections extend substantially into an area of an upper side of the vehicle battery.

6. The carrier according to claim 1, wherein the at least one holder is fixable on an upper side of the at least two projections.

7. The carrier according to claim 1, further comprising at least one clamping wedge disposed on the base and extending onto a contact surface.

8. The carrier according to claim 1, wherein at least one of the at least two projections comprises a fixing point for attachment of the at least one holder through which the at least one holder is twisted about at least one spatial axis in a mounted state.

9. The carrier according to claim 8, wherein the fixing point comprises a curved contact surface that is configured to be brought into an operative position with a corresponding counter-contact surface of the at least one holder.

10. The carrier according to claim 9, wherein the curved contact surface is an inwardly curved contact surface.

11. The carrier according to claim 9, wherein the fixing point comprises a receptacle configured to receive a connecting element that is configured to connect the at least one holder.

12. The carrier according to claim 9, wherein the fixing point comprises a receptacle configured to receive a connecting element that is configured to connect to the carrier.

13. The carrier according to claim 9, wherein at least one of the at least two projections comprise the fixing point configured for detachable connection to the at least one holder.

14. The carrier according to claim 9, wherein the carrier comprises a lock configured to fix the at least one holder in a second position in which an insertion region for insertion of the vehicle battery from above is exposed between the at least two projections.
